(19) United States
(12) Patent Application Publication
(10) Pub. No.: US 2025/0030167 A1
(43) Pub. Date: Jan. 23, 2025

(54) ANTENNA STRUCTURE

(71) Applicants: Yun-Chan TSAI, Taipei City (TW); ONEWAVE TECHNOLOGY CO., LTD., Taipei City (TW)

(72) Inventors: Yun-Chan TSAI, Taipei City (TW); Po-Huai HUANG, Taipei City (TW); Shi-Hong YANG, Taipei City (TW); Shi-Yu CHIU, Taipei City (TW)

(21) Appl. No.: 18/222,819

(22) Filed: Jul. 17, 2023

(51) Int. Cl. H01Q 9/30; H01Q 5/45

(52) U.S. Cl. CPC H01Q 9/30; H01Q 5/45

(57) ABSTRACT

An antenna structure electrically fixed on a main board of an electronic apparatus includes a high-frequency-radiation layer, a low-frequency-radiation layer, an electrode layer and a circuit board including a front surface, a back surface, and a notch. The notch allows a left pin and a right pin formed on a lower side of the circuit board. The high-frequency-radiation layer is arranged on the front surface. The low-frequency-radiation layer is arranged on the front surface or the back surface. A coupling gap is formed between the low-frequency-radiation layer and the high-frequency-radiation layer. The electrode layer is arranged on the left pin and the right pin, and electrically connected to the high-frequency-radiation layer and the low-frequency-radiation layer. The antenna structure belongs to the monopole-feed-in-coupling-loop-grounding design. When used in the main boards of different sizes, variation in grounding has a very little effect on the efficiency attenuation of the antenna structure.

### BACKGROUND OF THE DISCLOSURE

### Technical Field

The present disclosure relates to an antenna, and especially relates to an antenna structure with a monopole feed-in coupling loop grounding design, and is an antenna structure vertically and electrically fixed to a main board of an electronic apparatus.

### Description of Related Art

With the popularity of the Internet, people are increasingly dependent on the Internet, and more and more Internet apparatuses have been developed, such as Wi-Fi products, network communication products, Internet of Things, webcams, IP CAM, routers, or modems and so on. Most of the antenna structures used in these apparatuses are made of different radiation layer patterns on the copper foils on the circuit boards to receive and transmit signals.

Since the antenna structures used in the past belong to the monopole type multi-path design, the disadvantage is that when the antenna structure is used in the printed circuit board (PCB) of different sizes in different environments (arranged on the internal main board of different electronic product), if the grounding (GND) area is smaller, the effect on the performance attenuation of the antenna is greater, which reduces the receiving and transmitting capabilities of the antenna structure.

Therefore, how to make the variation in grounding (GND) have a very little effect on the efficiency attenuation of the antenna with the different sizes of the printed circuit board (PCB) in different environments is the main problem to be solved in the present disclosure.

### SUMMARY OF THE DISCLOSURE

Therefore, the main object of the present disclosure is to solve the traditional deficiency. The antenna structures of the new design of the present disclosure belong to the monopole feed-in coupling loop grounding design. When used in the main boards (PCB) of the electronic apparatuses of different sizes in different environments, the variation in grounding (GND) of the main board has a very little effect on the efficiency attenuation of the antenna structure to improve the receiving and transmitting capabilities of the antenna structure. The antenna structures of the present disclosure may be applied to the single-frequency, the dual-frequency, or the triple-frequency designs, and may be applied to Wi-Fi products, network communication products, Internet of Things, IP CAM, routers, or modems and so on.

In order to achieve the object mentioned above, the present disclosure provides an antenna structure which is electrically fixed on a main board of an electronic apparatus and which includes a circuit board, a high-frequency-radiation layer, a low-frequency-radiation layer, and an electrode layer. The circuit board is a square body and includes a front surface and a back surface. The circuit board defines/includes a notch on a lower side of the circuit board. The notch allows the circuit board to include/form a left pin and a right pin on the lower side of the circuit board. The high-frequency-radiation layer is a square and arranged on a lower right side of the front surface of the circuit board, and is located above the notch and the right pin. The low-frequency-radiation layer is an inverted L-shaped and arranged on an upper side and a left side of the front surface of the circuit board, and is located on the left pin. In addition, the antenna structure defines/forms/includes a coupling gap between the low-frequency-radiation layer and the high-frequency-radiation layer. The electrode layer is arranged on the front surface and the back surface of the left pin and the right pin, and is electrically connected to the high-frequency-radiation layer and the low-frequency-radiation layer.

In an embodiment of the present disclosure, the high-frequency-radiation layer includes an extended segment on a side edge of the high-frequency-radiation layer; the extended segment is electrically connected to the electrode layer.

In an embodiment of the present disclosure, a frequency of the high-frequency-radiation layer is 5.15 GHz˜5.85 GHz and 5.92 GHz˜7.12 GHz.

In an embodiment of the present disclosure, a frequency of the low-frequency-radiation layer is 2.4 GHz˜2.5 GHz.

In an embodiment of the present disclosure, the electrode layer includes a plurality of bonding pads arranged on the front surface and the back surface of the left pin and the right pin respectively.

In an embodiment of the present disclosure, the antenna structure further includes a fixing layer arranged on the front surface and the back surface of the circuit board, and arranged on a side of the notch.

In an embodiment of the present disclosure, the main board defines/includes two connection holes connected/engaged with the left pin and the right pin of the circuit board. The main board includes a signal feed-in layer and a first ground layer on a front face of the main board. One end of the signal feed-in layer is extended to one of the two connection holes. The first ground layer includes a ground line extended from the other one of the two connection holes. The left pin and the right pin of the circuit board are respectively plugged into the two connection holes, and the electrode layer is electrically connected to the ground line and the signal feed-in layer. Moreover, the main board includes a clearance area and a second ground layer arranged on a back face of the main board. The clearance area is corresponding to positions of the two connection holes. The second ground layer is corresponding to the first ground layer.

In an embodiment of the present disclosure, the main board further includes a fixing part between the two connection holes. The left pin and the right pin of the circuit board are respectively plugged into the two connection holes, and the fixing part is fixed to the fixing layer.

In order to achieve the object mentioned above, the present disclosure provides another antenna structure which is electrically fixed on a main board of an electronic apparatus and which includes a circuit board, a high-frequency-radiation layer, a low-frequency-radiation layer, and an electrode layer. The circuit board is a square body and includes a front surface and a back surface. The circuit board defines/includes a notch on a lower side of the circuit board. The notch allows the circuit board to include/form a left pin and a right pin on the lower side of the circuit board. The high-frequency-radiation layer is arranged on the front surface of the circuit board. The low-frequency-radiation layer is arranged on the back surface of the circuit board. The antenna structure defines/forms/includes a coupling gap between the high-frequency-radiation layer and the low-frequency-radiation layer which is corresponding to the high-frequency-radiation layer. The electrode layer is arranged on the front surface and the back surface of the left pin and the right pin, and is electrically connected to the high-frequency-radiation layer and the low-frequency-radiation layer.

In an embodiment of the present disclosure, the high-frequency-radiation layer is arranged on a lower right side of the front surface of the circuit board, and is located above the notch and the right pin. The high-frequency-radiation layer includes a longitudinal line segment, a first transverse line segment, a second transverse line segment and a third transverse line segment. The first transverse line segment, the second transverse line segment and the third transverse line segment are connected to one side of the longitudinal line segment, and are in a trident shape.

In an embodiment of the present disclosure, a frequency of the high-frequency-radiation layer is 5.15 GHz˜5.85 GHz and 5.92 GHZ˜7.12 GHz.

In an embodiment of the present disclosure, the low-frequency-radiation layer is an F-shaped, and arranged on an upper side and a left side of the back surface of the circuit board, and electrically connected to the electrode layer of the back surface of the left pin. The antenna structure defines/forms/includes the coupling gap between the high-frequency-radiation layer and a transverse line segment which is corresponding to a central location of the F-shaped of the low-frequency-radiation layer on the back surface of the circuit board.

In an embodiment of the present disclosure, a frequency of the low-frequency-radiation layer is 2.4 GHz˜2.5 GHz.

In an embodiment of the present disclosure, the electrode layer includes a plurality of bonding pads arranged on the front surface and the back surface of the left pin and the right pin respectively.

In an embodiment of the present disclosure, the main board defines/includes two connection holes connected/engaged with the left pin and the right pin of the circuit board. The main board includes a signal feed-in layer and a first ground layer on a front face of the main board. One end of the signal feed-in layer is extended to one of the two connection holes. The first ground layer includes a ground line extended from the other one of the two connection holes. The left pin and the right pin of the circuit board are respectively plugged into the two connection holes, and the electrode layer is electrically connected to the ground line and the signal feed-in layer. Moreover, the main board includes a clearance area and a second ground layer arranged on a back face of the main board. The clearance area is corresponding to positions of the two connection holes. The second ground layer is corresponding to the first ground layer.

In an embodiment of the present disclosure, the high-frequency-radiation layer is a square and arranged on the front surface of the circuit board, and is located above the notch, the right pin, and a part of the left pin. Moreover, the high-frequency-radiation layer includes a beveled side in a bottom edge of the high-frequency-radiation layer; the beveled side is electrically connected to the electrode layer.

In an embodiment of the present disclosure, a frequency of the high-frequency-radiation layer is 5.15 GHz˜5.85 GHz and 5.92 GHz˜7.12 GHz.

In an embodiment of the present disclosure, the low-frequency-radiation layer is arranged on the back surface of the circuit board. The low-frequency-radiation layer includes a first longitudinal line segment, a transverse line segment and a second longitudinal line segment. The first longitudinal line segment is arranged above a right side of the back surface of the circuit board. One end of the first longitudinal line segment is electrically connected to the transverse line segment. The second longitudinal line segment is arranged below a left side of the back surface of the circuit board and extended onto the left pin. One end of the second longitudinal line segment is electrically connected to the other end of the transverse line segment. The other end of the second longitudinal line segment is electrically connected to the bonding pad of the electrode layer. The antenna structure defines/forms/includes the coupling gap between the transverse line segment and the second longitudinal line segment of the low-frequency-radiation layer and an upper-edge side and a left-edge side of the high-frequency-radiation layer on the front surface of the circuit board.

In an embodiment of the present disclosure, a frequency of the low-frequency-radiation layer is 2.4 GHz˜2.5 GHz.

In an embodiment of the present disclosure, the electrode layer includes a plurality of bonding pads arranged on the front surface and the back surface of the left pin and the right pin respectively.

In an embodiment of the present disclosure, the main board defines/includes two connection holes connected/engaged with the left pin and the right pin of the circuit board. The main board includes a signal feed-in layer and a first ground layer on a front face of the main board. One end of the signal feed-in layer is extended to one of the two connection holes. The first ground layer includes a ground line extended from the other one of the two connection holes. The left pin and the right pin of the circuit board are respectively plugged into the two connection holes, and the electrode layer is electrically connected to the ground line and the signal feed-in layer. Moreover, the main board includes a clearance area and a second ground layer arranged on a back face of the main board. The clearance area is corresponding to positions of the two connection holes. The second ground layer is corresponding to the first ground layer.

### BRIEF DESCRIPTION OF THE DRAWINGS

FIG. 1 shows an exploded schematic diagram of the antenna structure and the main board of the first embodiment of the present disclosure.

FIG. 2 shows an exploded schematic diagram of the antenna structure and the main board from another perspective in FIG. 1.

FIG. 3 shows a schematic diagram of the three-dimensional combination of FIG. 1.

FIG. 4 shows a schematic diagram of the three-dimensional combination of FIG. 2.

FIG. 5 shows an exploded schematic diagram of the antenna structure and the main board of the second embodiment of the present disclosure.

FIG. 6 shows an exploded schematic diagram of the antenna structure and the main board from another perspective in FIG. 5.

FIG. 7 shows a schematic diagram of the three-dimensional combination of FIG. 5.

FIG. 8 shows a schematic diagram of the three-dimensional combination of FIG. 6.

FIG. 9 shows an exploded schematic diagram of the antenna structure and the main board of the third embodiment of the present disclosure.

FIG. 10 shows an exploded schematic diagram of the antenna structure and the main board from another perspective in FIG. 9.

FIG. 11 shows a schematic diagram of the three-dimensional combination of FIG. 9.

FIG. 12 shows a schematic diagram of the three-dimensional combination of FIG. 10.

### DETAILED DESCRIPTION

The technical content and detailed description of the present disclosure are hereby explained as follows with the diagrams:

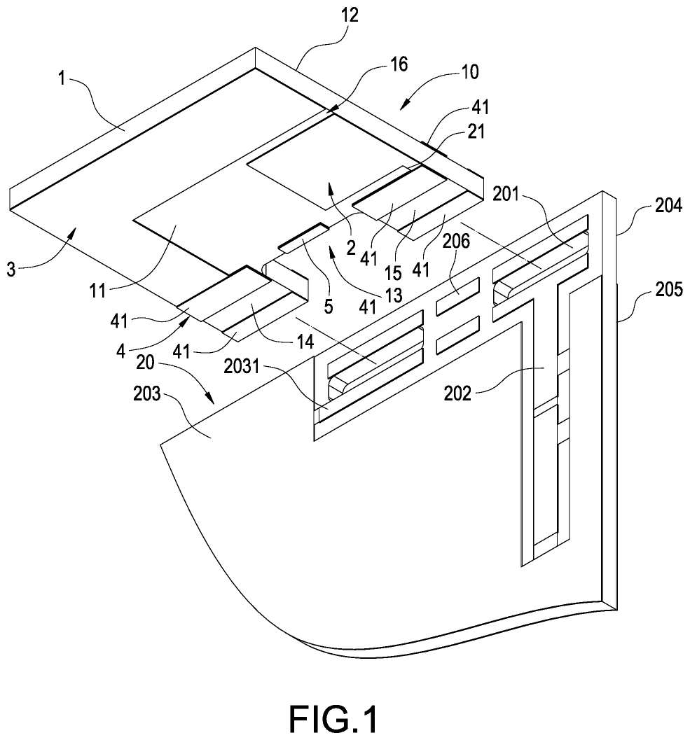

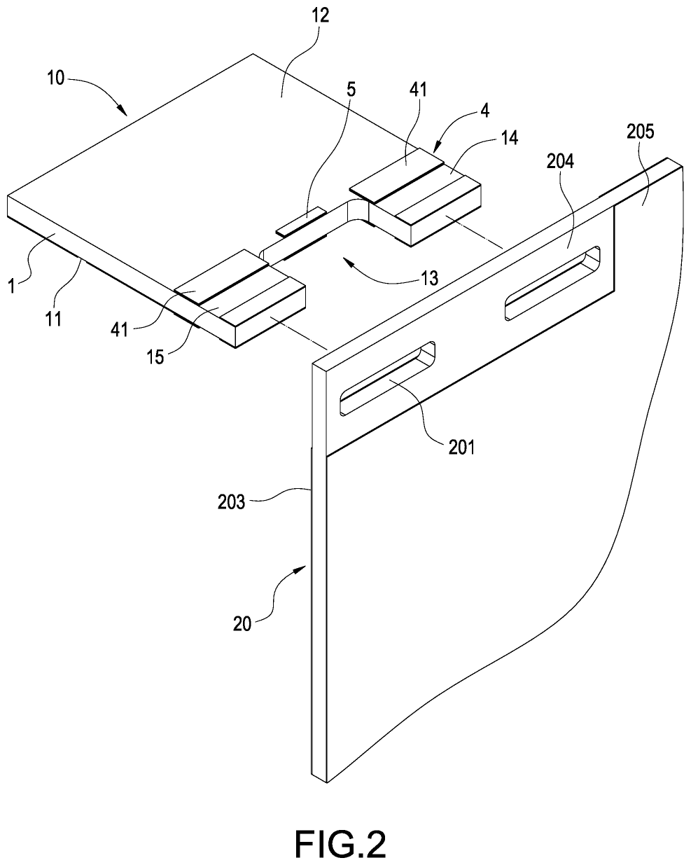

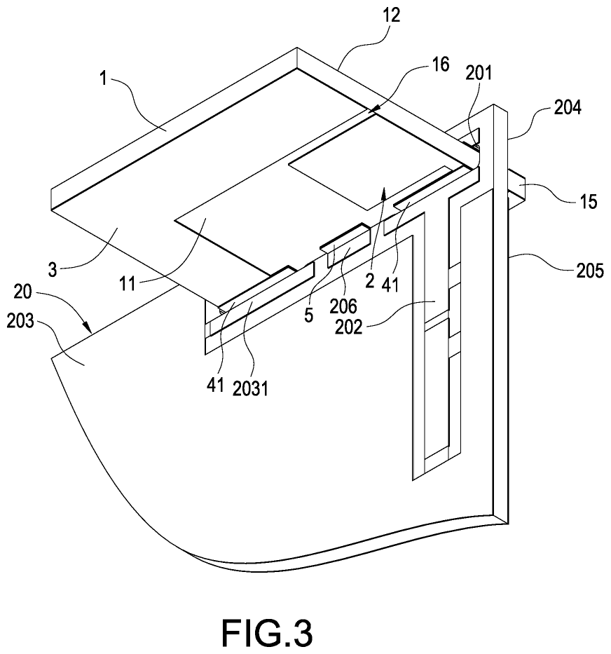

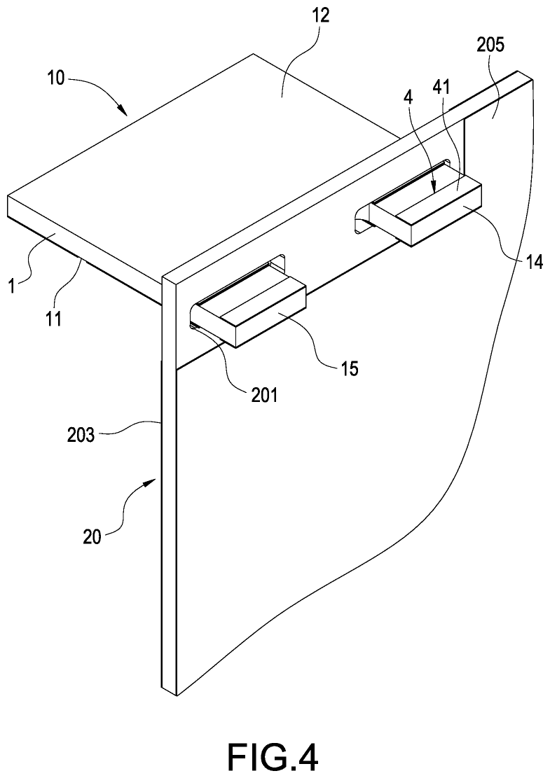

FIG. 1 shows an exploded schematic diagram of the antenna structure and the main board of the first embodiment of the present disclosure. FIG. 2 shows an exploded schematic diagram of the antenna structure and the main board from another perspective in FIG. 1. FIG. 3 shows a schematic diagram of the three-dimensional combination of FIG. 1. FIG. 4 shows a schematic diagram of the three-dimensional combination of FIG. 2. As shown in FIGS. 1˜4, the antenna structure 10 of the present disclosure includes a circuit board 1, a high-frequency-radiation layer 2, a low-frequency-radiation layer 3, an electrode layer 4 and a fixing layer 5.

The circuit board 1 is a square body and includes a front surface 11 and a back surface 12. The circuit board 1 defines/includes a notch 13 on a lower side of the circuit board 1. The notch 13 allows the circuit board 1 to include/form a left pin 14 and a right pin 15 on the lower side of the circuit board 1. In FIGS. 1˜4, the circuit board 1 is a printed circuit board.

The high-frequency-radiation layer 2 is a square and arranged on a lower right side of the front surface 11 of the circuit board 1, and is located above the notch 13 and the right pin 15 of the circuit board 1. Moreover, the high-frequency-radiation layer 2 includes an extended segment 21 on a side edge of the high-frequency-radiation layer 2; the extended segment 21 is electrically connected to the electrode layer 4, so that the high-frequency-radiation layer 2 is electrically connected to a signal feed-in layer 202 of a main board 20. In FIGS. 1˜4, a frequency (for example, a working frequency) of the high-frequency-radiation layer 2 is 5 GHz˜8 GHZ, for examples, 5.15 GHz˜5.85 GHz and 5.92 GHz˜7.12 GHz.

The low-frequency-radiation layer 3 is an inverted L-shaped and arranged on an upper side and a left side of the front surface 11 of the circuit board 1, and is located on the left pin 14, and is electrically connected to the electrode layer 4. In addition, the antenna structure 10 defines/forms/includes a coupling gap 16 between the low-frequency-radiation layer 3 on an upper side of the circuit board 1 and the high-frequency-radiation layer 2. In FIGS. 1˜4, a frequency (for example, a working frequency) of the low-frequency-radiation layer 3 is 2.4 GHz˜2.5 GHz.

The electrode layer 4 includes a plurality of bonding pads 41 arranged on the front surface and the back surface of the left pin 14 and the right pin 15 respectively. The bonding pads 41 are electrically connected to the high-frequency-radiation layer 2 and the low-frequency-radiation layer 3 to provide the high-frequency-radiation layer 2 and the signal feed-in layer 202 of the main board 20 with electrical connection, and to provide the low-frequency-radiation layer 3 and a first ground layer 203 of the main board 20 with electrical connection.

The fixing layer 5 is arranged on the front surface 11 and the back surface 12 of the circuit board 1, and arranged on a side of the notch 13. When the antenna structure 10 is fixed to the main board 20 of the electronic apparatus, the fixing layer 5 is fixed to a fixing part 206 of the main board 20, so that the antenna structure 10 is firmly fixed on the main board 20.

The main board 20 defines/includes two connection holes 201. The main board 20 includes a signal feed-in layer 202 and a first ground layer 203 on a front face of the main board 20. One end of the signal feed-in layer 202 is extended to one of the two connection holes 201. The first ground layer 203 includes a ground line 2031 extended from the other one of the two connection holes 201. When the antenna structure 10 of the present disclosure is used with the main board 20 of the electronic apparatus, the two connection holes 201 are connected/engaged with the left pin 14 and the right pin 15 of the circuit board 1. When the left pin 14 and the right pin 15 of the circuit board 1 are respectively plugged into the two connection holes 201, the bonding pads 41 of the electrode layer 4 of the left pin 14 are electrically connected to the ground line 2031, and the bonding pads 41 of the electrode layer 4 are electrically connected to the signal feed-in layer 202. Moreover, the main board 20 includes a clearance area 204 and a second ground layer 205 arranged on a back face of the main board 20. The clearance area 204 is corresponding to positions of the two connection holes 201. The second ground layer 205 is corresponding to the first ground layer 203.

It is worth mentioning that the main board 20 further includes a fixing part 206 between the two connection holes 201. When the left pin 14 and the right pin 15 of the circuit board 1 are respectively plugged into the two connection holes 201, the fixing part 206 is fixed to the fixing layer 5 of the circuit board 1, so that the circuit board 1 may be vertically and firmly connected to the main board 20.

Because the antenna structure 10 described above belongs to the monopole feed-in coupling loop grounding design, when the size of the main board 20 (PCB) is different in different environments, the variation in grounding (GND) has a very little effect on the efficiency attenuation of the antenna structure 10 to improve the receiving and transmitting capabilities of the antenna structure 10. The antenna structure 10 of the present disclosure may be applied to Wi-Fi, network communication products, Internet of Things, IP CAM, routers, or modems and so on.

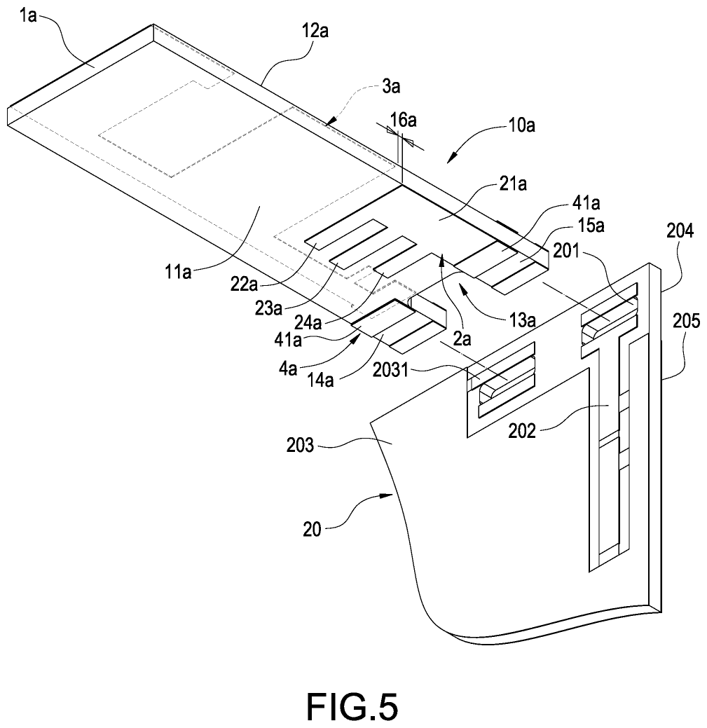

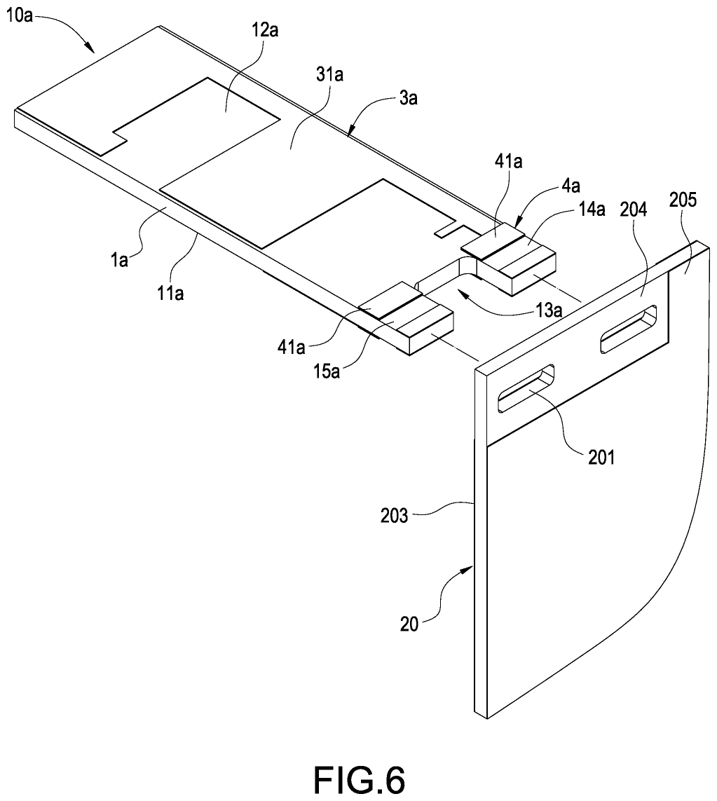

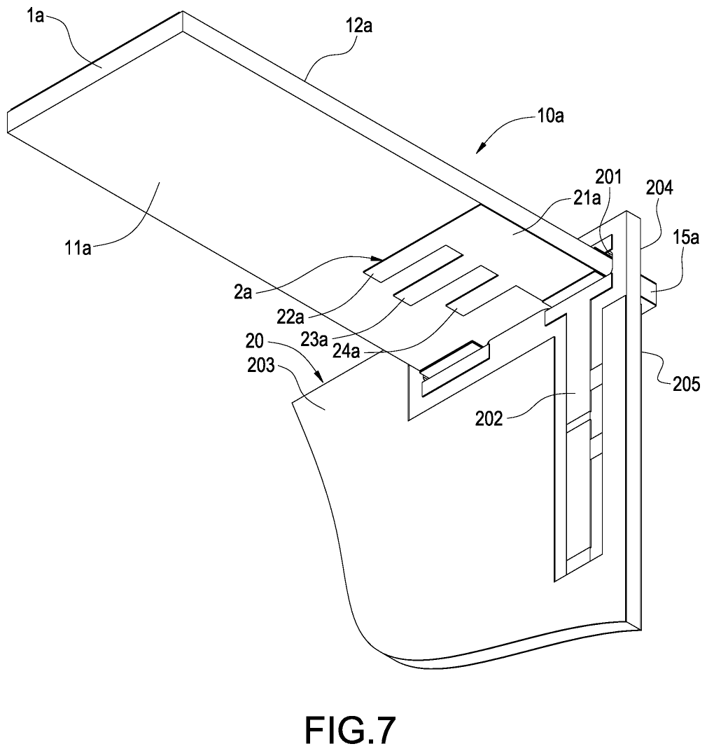

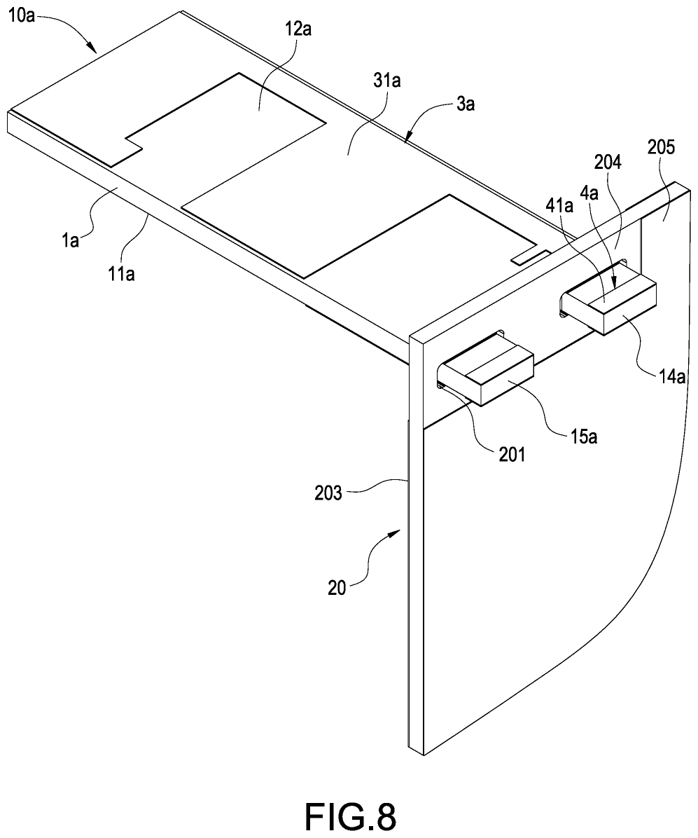

FIG. 5 shows an exploded schematic diagram of the antenna structure and the main board of the second embodiment of the present disclosure. FIG. 6 shows an exploded schematic diagram of the antenna structure and the main board from another perspective in FIG. 5. FIG. 7 shows a schematic diagram of the three-dimensional combination of FIG. 5. FIG. 8 shows a schematic diagram of the three-dimensional combination of FIG. 6. As shown in FIGS. 5˜8, the antenna structure of this embodiment is roughly the same as that of the first embodiment; the difference is that the antenna structure 10a includes a circuit board 1a, a high-frequency-radiation layer 2a, a low-frequency-radiation layer 3a and an electrode layer 4a.

The circuit board 1a is a rectangular body and includes a front surface 11a and a back surface 12a. The circuit board 1a defines/includes a notch 13a on a lower side of the circuit board 1a. The notch 13a allows the circuit board 1a to include/form a left pin 14a and a right pin 15a on the lower side of the circuit board 1a. In FIGS. 5˜8, the circuit board 1a is a printed circuit board.

The high-frequency-radiation layer 2a is arranged on a lower right side of the front surface 11a of the circuit board 1a, and is located above the notch 13a and the right pin 15a of the circuit board 1a. Moreover, the high-frequency-radiation layer 2a includes a longitudinal line segment 21a, a first transverse line segment 22a, a second transverse line segment 23a and a third transverse line segment 24a. The first transverse line segment 22a, the second transverse line segment 23a and the third transverse line segment 24a are connected to one side of the longitudinal line segment 21a, and are in a trident shape. The longitudinal line segment 21a is electrically connected to the electrode layer 4a, so that the high-frequency-radiation layer 2a is electrically connected to the signal feed-in layer 202 of the main board 20 through the electrode layer 4a. In FIGS. 5˜8, a frequency (for example, a working frequency) of the high-frequency-radiation layer 2a is 5 GHz˜8 GHz, for examples, 5.15 GHz˜5.85 GHz and 5.92 GHz˜7.12 GHz.

The low-frequency-radiation layer 3a is an F-shaped, and arranged on an upper side and a left side of the back surface 12a of the circuit board 1a, and electrically connected to the electrode layer 4a of the back surface 12a of the left pin 14a. The antenna structure 10a defines/forms/includes a coupling gap 16a between the high-frequency-radiation layer 2a and a transverse line segment 31a which is corresponding to a central location of the F-shaped of the low-frequency-radiation layer 3a on the back surface 12a of the circuit board 1a. In FIGS. 5˜8, a frequency (for example, a working frequency) of the low-frequency-radiation layer 3a is 2.4 GHz˜2.5 GHz.

The electrode layer 4a includes a plurality of bonding pads 41a arranged on the front surface and the back surface of the left pin 14a and the right pin 15a respectively. The bonding pads 41a are electrically connected to the high-frequency-radiation layer 2a and the low-frequency-radiation layer 3a to provide the high-frequency-radiation layer 2a and the signal feed-in layer 202 of the main board 20 with electrical connection, and to provide the low-frequency-radiation layer 3a and the first ground layer 203 of the main board 20 with electrical connection.

When the antenna structure 10a of the present disclosure is used with the main board 20 of the electronic apparatus, and when the left pin 14a and the right pin 15a of the circuit board 1a are respectively plugged into the two connection holes 201, the bonding pads 41a of the electrode layer 4a of the left pin 14a are electrically connected to the ground line 2031, and the bonding pads 41a of the electrode layer 4a are electrically connected to the signal feed-in layer 202.

Because the antenna structure 10a described above belongs to the monopole feed-in coupling loop grounding design, when the size of the main board 20 (PCB) is different in different environments, the variation in grounding (GND) has a very little effect on the efficiency attenuation of the antenna structure 10a to improve the receiving and transmitting capabilities of the antenna structure 10a. The antenna structure 10a of the present disclosure may be applied to Wi-Fi, network communication products, Internet of Things, IP CAM, routers, or modems and so on.

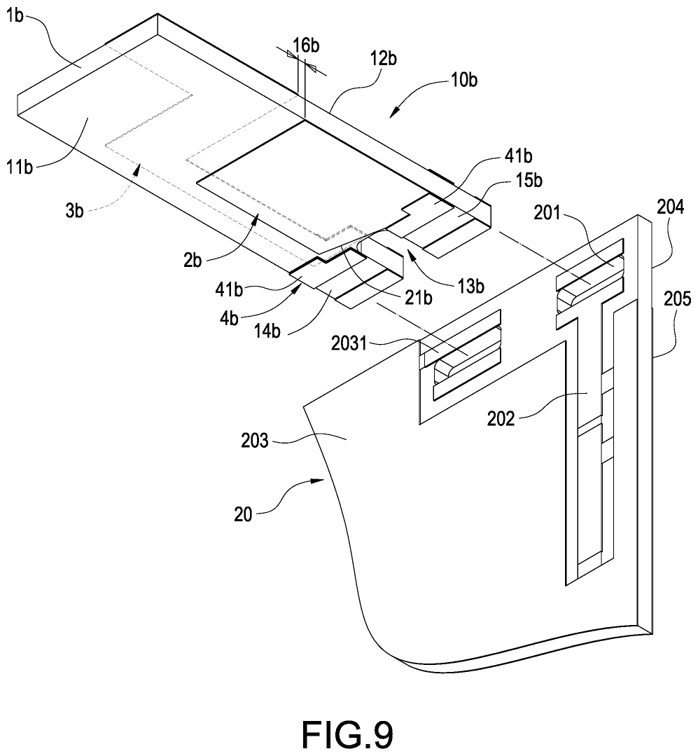

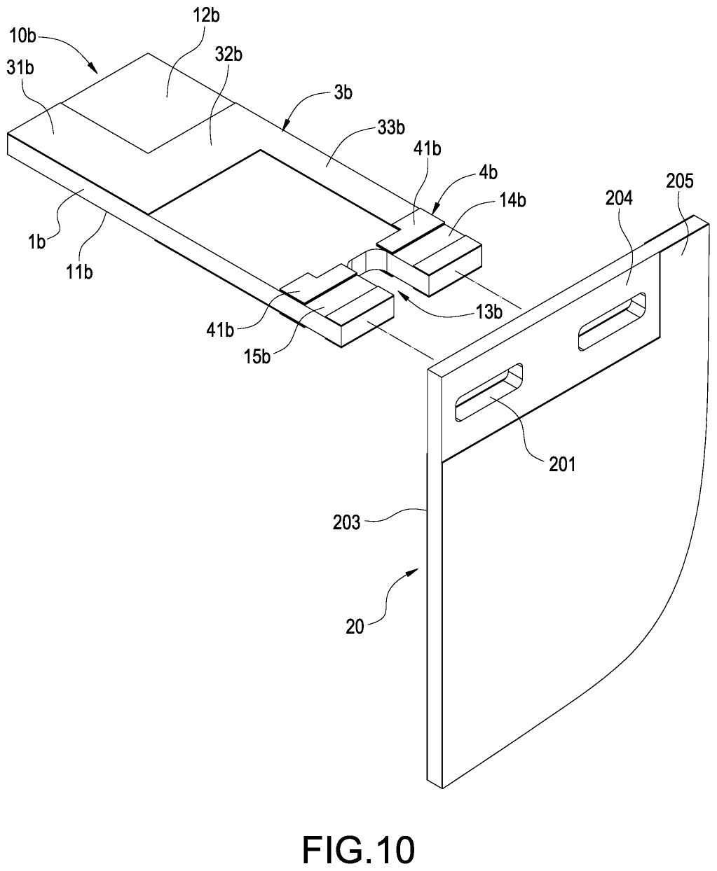

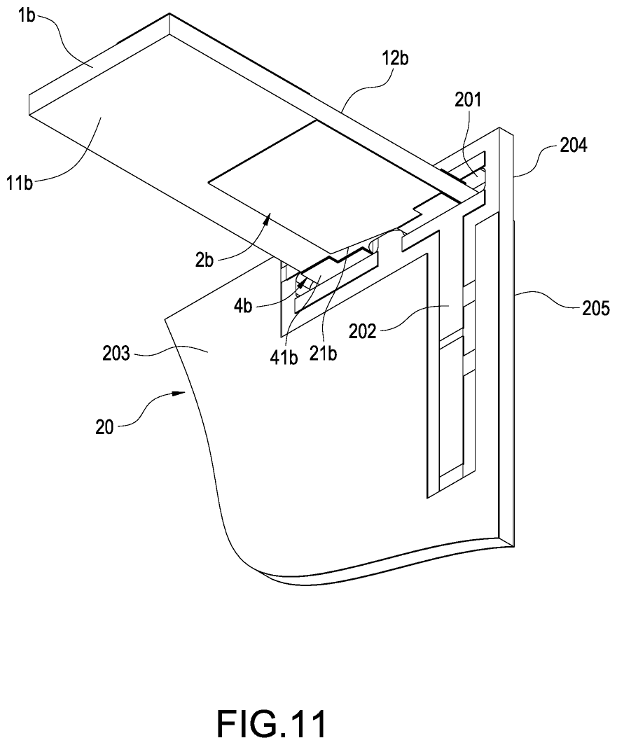

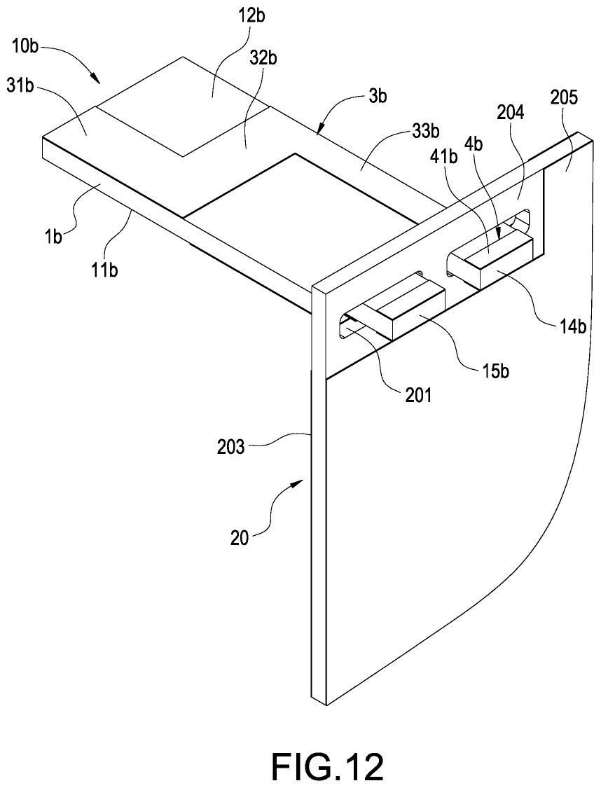

FIG. 9 shows an exploded schematic diagram of the antenna structure and the main board of the third embodiment of the present disclosure. FIG. 10 shows an exploded schematic diagram of the antenna structure and the main board from another perspective in FIG. 9. FIG. 11 shows a schematic diagram of the three-dimensional combination of FIG. 9. FIG. 12 shows a schematic diagram of the three-dimensional combination of FIG. 10. As shown in FIGS. 9˜12, the antenna structure 10b includes a circuit board 1b, a high-frequency-radiation layer 2b, a low-frequency-radiation layer 3b and an electrode layer 4b.

The circuit board 1b is a square body and includes a front surface 11b and a back surface 12b. The circuit board 1b defines/includes a notch 13b on a lower side of the circuit board 1b. The notch 13b allows the circuit board 1b to include/form a left pin 14b and a right pin 15b on the lower side of the circuit board 1b. In FIGS. 9˜12, the circuit board 1b is a printed circuit board.

The high-frequency-radiation layer 2b is a square and arranged on the front surface 11b of the circuit board 1b, and is located above the notch 13b, the right pin 15b and a part of the left pin 14b of the circuit board 1b. Moreover, the high-frequency-radiation layer 2b includes a beveled side 21b in a bottom edge of the high-frequency-radiation layer 2b; the beveled side 21b is electrically connected to the electrode layer 4b, so that the high-frequency-radiation layer 2b is electrically connected to the signal feed-in layer 202 of the main board 20 through the electrode layer 4b. In FIGS. 9˜12, a frequency (for example, a working frequency) of the high-frequency-radiation layer 2b is 5 GHz˜8 GHz, for examples, 5.15 GHz˜5.85 GHz and 5.92 GHz˜7.12 GHz.

The low-frequency-radiation layer 3b is arranged on the back surface 12b of the circuit board 1b. The low-frequency-radiation layer 3b includes a first longitudinal line segment 31b, a transverse line segment 32b and a second longitudinal line segment 33b. The first longitudinal line segment 31b is arranged above a right side of the back surface 12b of the circuit board 1b. One end of the first longitudinal line segment 31b is electrically connected to the transverse line segment 32b. The second longitudinal line segment 33b is arranged below a left side of the back surface 12b of the circuit board 1b and extended onto the left pin 14b. One end of the second longitudinal line segment 33b is electrically connected to the other end of the transverse line segment 32b. The other end of the second longitudinal line segment 33b is electrically connected to the bonding pad 41b of the electrode layer 4b. The antenna structure 10b defines/forms/includes a coupling gap 16b between the transverse line segment 32b and the second longitudinal line segment 33b of the low-frequency-radiation layer 3b and an upper-edge side 22b and a left-edge side 23b of the high-frequency-radiation layer 2b on the front surface 11b of the circuit board 1b. In FIGS. 9˜12, a frequency (for example, a working frequency) of the low-frequency-radiation layer 3b is 2.4 GHz˜2.5 GHz.

The electrode layer 4b includes a plurality of bonding pads 41b arranged on the front surface and the back surface of the left pin 14b and the right pin 15b respectively. The bonding pads 41b are electrically connected to the high-frequency-radiation layer 2b and the low-frequency-radiation layer 3b to provide the high-frequency-radiation layer 2b and the signal feed-in layer 202 of the main board 20 with electrical connection, and to provide the low-frequency-radiation layer 3b and the first ground layer 203 of the main board 20 with electrical connection.

When the antenna structure 10b of the present disclosure is used with the main board 20 of the electronic apparatus, and when the left pin 14b and the right pin 15b of the circuit board 1b are respectively plugged into the two connection holes 201, the bonding pads 41b of the electrode layer 4b of the left pin 14b are electrically connected to the ground line 2031, and the bonding pads 41b of the electrode layer 4b are electrically connected to the signal feed-in layer 202.

Because the antenna structure 10b described above belongs to the monopole feed-in coupling loop grounding design, when the size of the main board 20 (PCB) is different in different environments, the variation in grounding (GND) has a very little effect on the efficiency attenuation of the antenna structure 10b to improve the receiving and transmitting capabilities of the antenna structure 10b. The antenna structure 10b of the present disclosure may be applied to Wi-Fi, network communication products, Internet of Things, IP CAM, routers, or modems and so on.

However, the above description is only embodiments of the present disclosure, and is not intended to limit the scope of the patent protection of the present disclosure. Therefore, all equivalent changes made by using the contents of the specification or the drawings of the present disclosure are equally included in the scope of the claims.

What is claimed is:

1. An antenna structure electrically fixed on a main board of an electronic apparatus, the antenna structure comprising:
a circuit board being a square body, and comprising a front surface and a back surface, and defining a notch on a lower side of the circuit board, wherein the notch allows the circuit board to comprise a left pin and a right pin on the lower side of the circuit board;
a high-frequency-radiation layer being a square, and arranged on a lower right side of the front surface of the circuit board, and located above the notch and the right pin;
a low-frequency-radiation layer being an inverted L-shaped, and arranged on an upper side and a left side of the front surface of the circuit board, and located on the left pin, wherein the antenna structure defines a coupling gap between the low-frequency-radiation layer and the high-frequency-radiation layer; and
an electrode layer arranged on the front surface and the back surface of the left pin and the right pin, and electrically connected to the high-frequency-radiation layer and the low-frequency-radiation layer.

2. The antenna structure of claim 1, wherein the high-frequency-radiation layer comprises an extended segment on a side edge of the high-frequency-radiation layer; the extended segment is electrically connected to the electrode layer.

3. The antenna structure of claim 1, wherein a frequency of the high-frequency-radiation layer is 5.15 GHz˜5.85 GHz and 5.92 GHz˜7.12 GHz.

4. The antenna structure of claim 1, wherein a frequency of the low-frequency-radiation layer is 2.4 GHz˜2.5 GHz.

5. The antenna structure of claim 1, wherein the electrode layer comprises a plurality of bonding pads arranged on the front surface and the back surface of the left pin and the right pin respectively.

6. The antenna structure of claim 1, further comprising:
a fixing layer arranged on the front surface and the back surface of the circuit board, and arranged on a side of the notch.

7. The antenna structure of claim 6, wherein the main board defines two connection holes connected with the left pin and the right pin of the circuit board; the main board comprises a signal feed-in layer and a first ground layer on a front face of the main board; one end of the signal feed-in layer is extended to one of the two connection holes; the first ground layer comprises a ground line extended from the other one of the two connection holes; the left pin and the right pin of the circuit board are respectively plugged into the two connection holes, and the electrode layer is electrically connected to the ground line and the signal feed-in layer; the main board comprises a clearance area and a second ground layer arranged on a back face of the main board; the clearance area is corresponding to positions of the two connection holes; the second ground layer is corresponding to the first ground layer.

8. The antenna structure of claim 7, wherein the main board further comprises a fixing part between the two connection holes; the left pin and the right pin of the circuit board are respectively plugged into the two connection holes, and the fixing part is fixed to the fixing layer.

9. An antenna structure electrically fixed on a main board of an electronic apparatus, the antenna structure comprising:
a circuit board being a square body, and comprising a front surface and a back surface, and defining a notch on a lower side of the circuit board, wherein the notch allows the circuit board to comprise a left pin and a right pin on the lower side of the circuit board;
a high-frequency-radiation layer arranged on the front surface of the circuit board;
a low-frequency-radiation layer arranged on the back surface of the circuit board, wherein the antenna structure defines a coupling gap between the high-frequency-radiation layer and the low-frequency-radiation layer which is corresponding to the high-frequency-radiation layer; and
an electrode layer arranged on the front surface and the back surface of the left pin and the right pin, and electrically connected to the high-frequency-radiation layer and the low-frequency-radiation layer.

10. The antenna structure of claim 9, wherein the high-frequency-radiation layer is arranged on a lower right side of the front surface of the circuit board, and is located above the notch and the right pin; the high-frequency-radiation layer comprises a longitudinal line segment, a first transverse line segment, a second transverse line segment and a third transverse line segment; the first transverse line segment, the second transverse line segment and the third transverse line segment are connected to one side of the longitudinal line segment, and are in a trident shape.

11. The antenna structure of claim 9, wherein a frequency of the high-frequency-radiation layer is 5.15 GHz˜5.85 GHz and 5.92 GHz˜7.12 GHz.

12. The antenna structure of claim 11, wherein the low-frequency-radiation layer is an F-shaped, and is arranged on an upper side and a left side of the back surface of the circuit board, and is electrically connected to the electrode layer of the back surface of the left pin; the antenna structure defines the coupling gap between the high-frequency-radiation layer and a transverse line segment which is corresponding to a central location of the F-shaped of the low-frequency-radiation layer on the back surface of the circuit board.

13. The antenna structure of claim 12, wherein a frequency of the low-frequency-radiation layer is 2.4 GHz˜2.5 GHz.

14. The antenna structure of claim 13, wherein the electrode layer comprises a plurality of bonding pads arranged on the front surface and the back surface of the left pin and the right pin respectively.

15. The antenna structure of claim 14, wherein the main board defines two connection holes connected with the left pin and the right pin of the circuit board; the main board comprises a signal feed-in layer and a first ground layer on a front face of the main board; one end of the signal feed-in layer is extended to one of the two connection holes; the first ground layer comprises a ground line extended from the other one of the two connection holes; the left pin and the right pin of the circuit board are respectively plugged into the two connection holes, and the electrode layer is electrically connected to the ground line and the signal feed-in layer; the main board comprises a clearance area and a second ground layer arranged on a back face of the main board; the clearance area is corresponding to positions of the two connection holes; the second ground layer is corresponding to the first ground layer.

16. The antenna structure of claim 9, wherein the high-frequency-radiation layer is a square, and is arranged on the front surface of the circuit board, and is located above the notch, the right pin, and a part of the left pin; the high-frequency-radiation layer comprises a beveled side in a bottom edge of the high-frequency-radiation layer; the beveled side is electrically connected to the electrode layer.

17. The antenna structure of claim 16, wherein a frequency of the high-frequency-radiation layer is 5.15 GHz˜5.85 GHz and 5.92 GHz˜7.12 GHz.

18. The antenna structure of claim 17, wherein the low-frequency-radiation layer is arranged on the back surface of the circuit board; the low-frequency-radiation layer comprises a first longitudinal line segment, a transverse line segment and a second longitudinal line segment; the first longitudinal line segment is arranged above a right side of the back surface of the circuit board; one end of the first longitudinal line segment is electrically connected to the transverse line segment; the second longitudinal line segment is arranged below a left side of the back surface of the circuit board and extended onto the left pin; one end of the second longitudinal line segment is electrically connected to the other end of the transverse line segment; the other end of the second longitudinal line segment is electrically connected to the bonding pad of the electrode layer; the antenna structure defines the coupling gap between the transverse line segment and the second longitudinal line segment of the low-frequency-radiation layer and an upper-edge side and a left-edge side of the high-frequency-radiation layer on the front surface of the circuit board.

19. The antenna structure of claim 18, wherein a frequency of the low-frequency-radiation layer is 2.4 GHz˜2.5 GHz.

20. The antenna structure of claim 19, wherein the electrode layer comprises a plurality of bonding pads arranged on the front surface and the back surface of the left pin and the right pin respectively.

21. The antenna structure of claim 20, wherein the main board defines two connection holes connected with the left pin and the right pin of the circuit board; the main board comprises a signal feed-in layer and a first ground layer on a front face of the main board; one end of the signal feed-in layer is extended to one of the two connection holes; the first ground layer comprises a ground line extended from the other one of the two connection holes; the left pin and the right pin of the circuit board are respectively plugged into the two connection holes, and the electrode layer is electrically connected to the ground line and the signal feed-in layer; the main board comprises a clearance area and a second ground layer arranged on a back face of the main board; the clearance area is corresponding to positions of the two connection holes; the second ground layer is corresponding to the first ground layer.
